(19) United States
(12) Patent Application Publication
(10) Pub. No.: US 2013/0047380 A1
(43) Pub. Date: Feb. 28, 2013

(54) Fixed Handle Assembly

(71) Applicants: Ho-Ching Huang, Taipei (TW); Hui-Chen Wang, Taipei (TW); Yi-Chun Tang, Taipei (TW); Wen-Cheih Chen, Taipei (TW)

(72) Inventors: Ho-Ching Huang, Taipei (TW); Hui-Chen Wang, Taipei (TW); Yi-Chun Tang, Taipei (TW); Wen-Cheih Chen, Taipei (TW)

(73) Assignee: PEGATRON CORPORATION, Taipei City (TW)

(21) Appl. No.: 13/592,783

(22) Filed: Aug. 23, 2012

(30) Foreign Application Priority Data
Aug. 26, 2011 (TW) 100130736

(51) Int. Cl. B25G 1/04

(52) U.S. Cl. 16/429

(57) ABSTRACT

A fixed handle assembly used to a removable box that is removably assembled to a host housing is provided. The fixed handle assembly includes a hinge, a main body, and a fixing member. The hinge is disposed on the removable box. The main body is pivotally connected to the hinge. The fixing member is disposed on the host housing. The main body is rotatable relative to the removable box to approach the fixing member so as to be fixed by the fixing member detachably. When a separating force received by the main body is larger than a fixing force that the fixing member applies to the main body, the main body is capable of rotating relative to the removable box and separating from the fixing member.

### RELATED APPLICATIONS

This application claims priority to Taiwan Application Serial Number 100130736, filed Aug. 26, 2011, which is herein incorporated by reference.

### BACKGROUND

1. Technical Field

The present disclosure relates to a fixed handle assembly, and more particularly, to a fixed handle assembly for being installed on a removable box.

2. Description of Related Art

A Hard Disk Drive (HDD) is a non-volatile storage device using a hard rotatable disk and which is generally used in a computer. The flat magnetic surface of a HDD is used to store digital data. Information data is written to the magnetic surface by a read-write head close to the magnetic surface using electromagnetic flow to change the polarity of the magnetic surface. Information data on the magnetic surface can be read in the opposite manner.

In order to allow a computer to detect peripheral devices immediately, hot plugging technology is widely used. Therefore, with appropriate software, peripheral devices that support hot plugging can be connected to or disconnected from the host computer without turning off the power to the host computer.

In recent years, portable HDDs are being used more and more with computers. Furthermore, portable HDDs can be used with computers of several kinds of vehicles such as automobiles, motorcycles, trains, planes, ships, etc. To provide for carrying convenience, portable HDDs are usually equipped with handles. However, such vehicles vibrate when moving, so that the handles easily collide with the portable HDDs installed in the host computers thereof during operation, and this generates noise and may cause damage to the portable HDDs.

### SUMMARY

The disclosure provides an improved fixed handle assembly. The fixed handle assembly is used to a removable box and prevents a main body of the fixed handle assembly from shaking and colliding with the removable box during transportation or operation of the removable box. During transportation of the removable box, the main body is fixed to stand erect relative to a surface of the removable box by an engaging structure of the fixed handle assembly that is disposed between a hinge of the fixed handle assembly and the main body. During operation of the removable box after the removable box is assembled to a host housing, the main body is fixed to abut against the surface of the removable box by a fixing member of the removable box that is disposed on the host housing.

According to an embodiment of the disclosure, a fixed handle assembly is used to a removable box that is removably assembled to a host housing. The fixed handle assembly includes a hinge, a main body, and a fixing member. The hinge is disposed on the removable box. The main body is pivotally connected to the hinge. The fixing member is disposed on the host housing. The main body is rotatable relative to the removable box to approach the fixing member so as to be fixed by the fixing member detachably. When a separating force received by the main body is larger than a fixing force that the fixing member applies to the main body, the main body is capable of rotating relative to the removable box and separating from the fixing member.

In an embodiment of the disclosure, the fixing member is a magnetic attraction member. A material of the main body includes metal. When the main body rotates relative to the removable box to approach the magnetic attraction member, the magnetic attraction member attracts and fixes the main body detachably.

In an embodiment of the disclosure, the main body includes an end and a pivot. The hinge includes an accommodating trough. The end is pivotally connected to the hinge by the pivot and is located at least partially in the accommodating trough so as to rotate within the accommodating trough. The main body is capable of rotating relative to the removable box to approach or separate from the fixing member.

In an embodiment of the disclosure, the hinge includes a first recess and a second recess within the accommodating trough. The end includes a protrusion engageable with the first recess or the second recess. When the main body rotates relative to the removable box to fix to the fixing member, the protrusion is engaged with the first recess. When the main body rotates relative to the removable box to be perpendicular to a surface of the removable box, the protrusion is engaged with the second recess.

In an embodiment of the disclosure, the protrusion is located at a first operation surface of the end, and the first operation surface is perpendicular to the pivot.

In an embodiment of the disclosure, the hinge includes a recess within the accommodating trough. The end includes a first protrusion and a second protrusion engageable with the recess. When the main body rotates relative to the removable box to fix to the fixing member, the first protrusion is engaged with the recess. When the main body rotates relative to the removable box to be perpendicular to a surface of the removable box, the second protrusion is engaged with the recess.

In an embodiment of the disclosure, the first protrusion and the second protrusion are located at a second operation surface of the end, and the second operation surface is parallel to the pivot.

In an embodiment of the disclosure, when the main body rotates relative to the removable box to fix to the fixing member, the main body is parallel to a surface of the removable box.

In an embodiment of the disclosure, the fixing member is a hook. The main body includes an engaging trough. When the main body rotates relative to the removable box to approach the hook, the hook is engaged in the engaging trough to fix the main body.

In an embodiment of the disclosure, the hook includes a neck portion and a head portion. The engaging trough has an opening. The opening is compressible by the head portion to expand, and elastically recovers to limit the movement of the head portion after the head portion passes through the opening and then is engaged with the engaging trough.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1A is a perspective view of a fixed handle assembly applied to a removable box that is removably assembled to a host housing according to an embodiment of the disclosure;

FIG. 1B is a side view showing the removable box assembled to the host housing in FIG. 1A, in which a main body of the fixed handle assembly rotates relative to the removable box to fix to a magnetic attraction member;

FIG. 2A is a perspective view of a hinge in FIG. 1A;

FIG. 2B is a partial perspective view of the main body in FIG. 1A;

FIG. 3A is a partial perspective view of FIG. 1A, in which the main body rotates relative to the removable box to fix to the magnetic attraction member;

FIG. 3B is another partial perspective view of FIG. 1A, in which the main body rotates relative to the removable box to be perpendicular to a surface of the removable box;

FIG. 4A is a perspective view of another embodiment of the hinge in FIG. 1A;

FIG. 4B is a partial perspective view of another embodiment of the main body in FIG. 1A;

FIG. 5A is a partial sectional view showing the main body in FIG. 4B assembled to the hinge in FIG. 4A, in which the main body rotates relative to the removable box to approach the surface of the removable box;

FIG. 5B is another partial sectional view showing the main body in FIG. 4B assembled to the hinge in FIG. 4A, in which the main body rotates relative to the removable box to be perpendicular to the surface of the removable box;

FIG. 6A is a perspective view showing a hook of a fixed handle assembly that is disposed on the host housing according to another embodiment of the disclosure;

FIG. 6B is a perspective view of a main body of the fixed handle assembly according to another embodiment of the disclosure; and

FIG. 6C is another side view of FIG. 1B that adopts the fixed handle assembly in FIG. 6B according to another embodiment of the disclosure, in which the main body rotates relative to the removable box to fix to the hook, and an engaging trough of the main body is shown in cross section.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

An improved fixed handle assembly is provided. Specifically, the fixed handle assembly is used to a removable box and prevents a main body of the fixed handle assembly from shaking to thereby make noise or collide with the removable box, and can also prevent damage to the removable box that may be caused by vibration during transportation or operation of the removable box. During transportation of the removable box, the main body can be fixed to stand erect relative to a surface of the removable box by an engaging structure of the fixed handle assembly that is disposed between a hinge of the fixed handle assembly and the main body. During operation of the removable box after the removable box is assembled to a host housing, the main body can be fixed to abut against the surface of the removable box by a fixing member of the removable box that is disposed on the host housing.

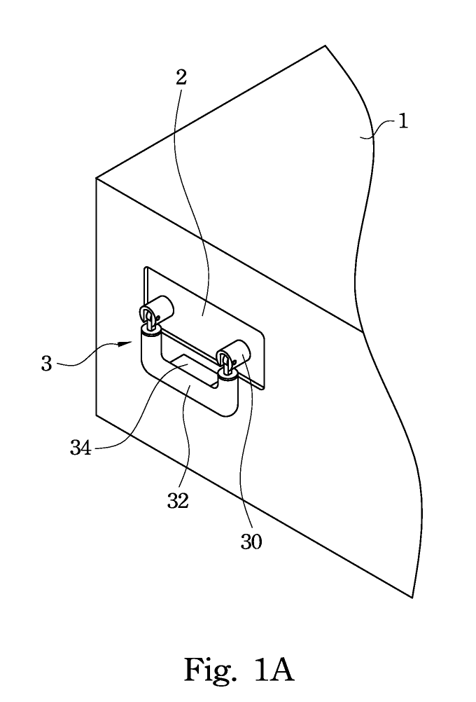

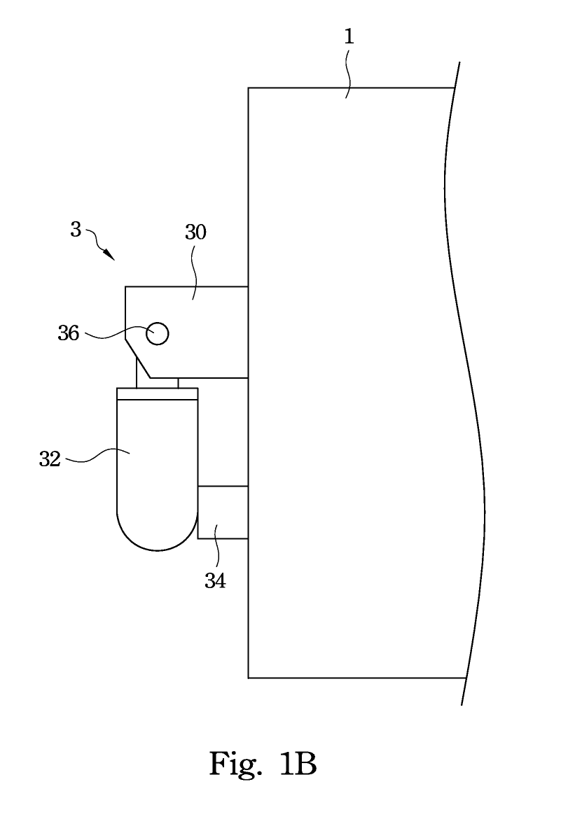

FIG. 1A is a perspective view of a fixed handle assembly 3 applied to a removable box 2 that is removably assembled to a host housing 1 according to an embodiment of the disclosure. FIG. 1B is a side view showing the removable box 2 assembled to the host housing 1 in FIG. 1A, in which a main body 32 of the fixed handle assembly 3 rotates relative to the removable box 2 to fix to a magnetic attraction member 34.

As shown in FIG. 1A and FIG. 1B, the fixed handle assembly 3 of the disclosure can be applied to the removable box 2 that is removably assembled to the host housing 1. For example, the foregoing host housing 1 can be a housing of a host computer used in a vehicle such as an automobile, a motorcycle, a train, a plane, a ship, etc., and the foregoing removable box 2 can be a removable box of a portable HDD, but the disclosure is not limited in this regard. The fixed handle assembly 3 of the disclosure can prevent the main body 32 of the fixed handle assembly 3 from shaking to make noise or collide with the removable box 2 to damage the removable box 2 and/or the fixed handle assembly 3 due to vibration during transportation or operation of the removable box 2.

As shown in FIG. 1A and FIG. 1B, the fixed handle assembly 3 includes a hinge 30, the main body 32, a pivot 36, and a magnetic attraction member 34. The magnetic attraction member 34 can be a powerful magnet, but the disclosure is not limited in this regard. The hinge 30 of the fixed handle assembly 3 is disposed on the removable box 2. The main body 32 of the fixed handle assembly 3 includes an end 320, and the end 320 of the main body 32 is pivotally connected to the hinge 30 by using the pivot 36. The magnetic attraction member 34 of the fixed handle assembly 3 is disposed on the host housing 1. When the main body 32 rotates relative to the removable box 2 to approach the magnetic attraction member 34 (as FIG. 1B shows), the magnetic attraction member 34 is located corresponding to where the main body 32 is positioned so as to attract and fix the main body 32. In the embodiment of the disclosure, the material of the main body 32 of the fixed handle assembly 3 includes metal. Therefore, the main body 32 must receive a separating force that is larger than a fixing force that the magnetic attraction member 34 applies to the main body 32 in order to rotate relative to the removable box 2 and separate from the magnetic attraction member 34. That is, when the removable box 2 is assembled to the host housing 1 and in use, the magnetic attraction member 34 continuously applies the fixing force to the main body 32 so as to ensure that the main body 32 does not shake and collide with the removable box 2.

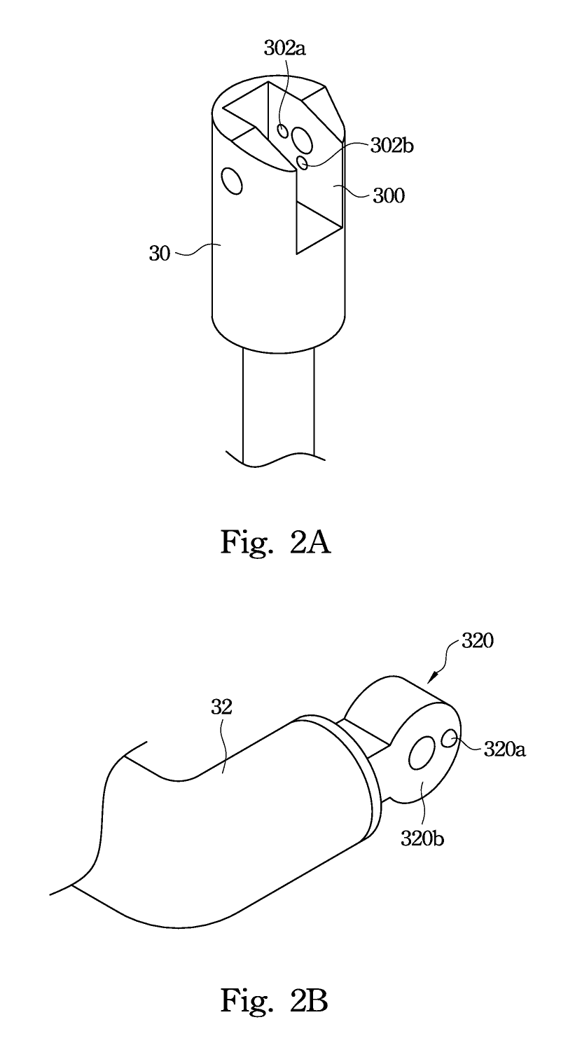

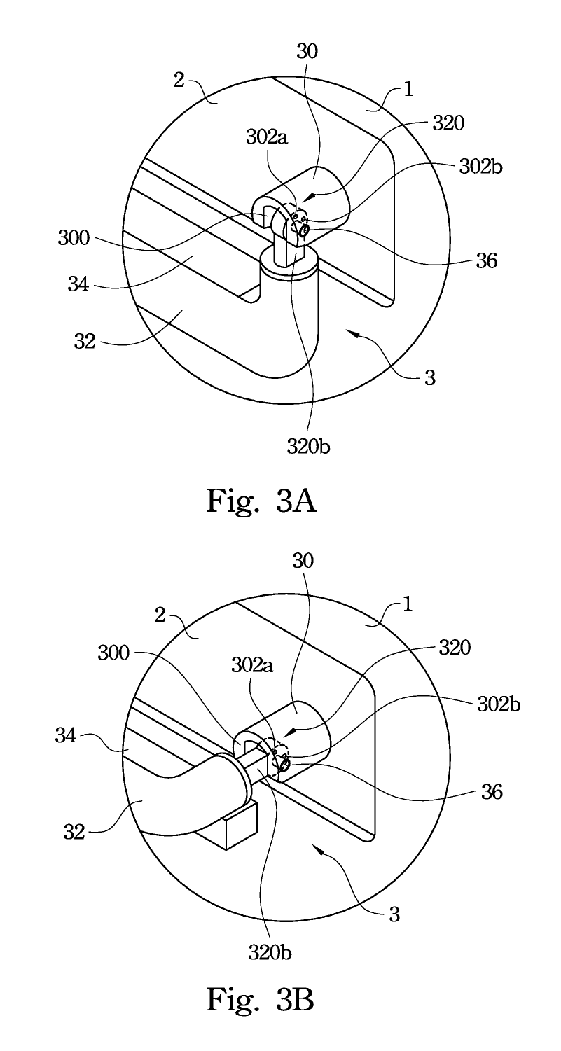

FIG. 2A is a perspective view of the hinge 30 in FIG. 1A. FIG. 2B is a partial perspective view of the main body 32 in FIG. 1A. FIG. 3A is a partial perspective view of FIG. 1A, in which the main body 32 rotates relative to the removable box 2 to fix to the magnetic attraction member 34. FIG. 3B is another partial perspective view of FIG. 1A, in which the main body 32 rotates relative to the removable box 2 to be perpendicular to a surface of the removable box 2.

As shown in FIG. 2A to FIG. 3B, the hinge 30 of the fixed handle assembly 3 includes an accommodating trough 300. The pivot 36 of the fixed handle assembly 3 is pivotally connected to the hinge 30 and passes through the accommodating trough 300. The end 320 of the main body 32 is pivotally connected to the hinge 30 by the pivot 36 and is located at least partially in the accommodating trough 300 so as to rotate within the accommodating trough 300 and make the main body 32 rotate relative to the removable box 2 to approach the magnetic attraction member 34 (as FIG. 3A shows) or separate from the magnetic attraction member 34 (as FIG. 3B shows). When the main body 32 rotates relative to the removable box 2 to fix to magnetic attraction member 34, the main body 32 is parallel to the surface of the removable box 2.

As shown in FIG. 2A to FIG. 3B, the hinge 30 includes a first recess 302a and a second recess 302b within the accommodating trough 300, and the end 320 of the main body 32 includes a protrusion 320a. During rotation of the main body 32 relative to the removable box 2 to fix to the magnetic attraction member 34 or to be perpendicular to the surface of the removable box 2, the protrusion 320a of the main body 32 and the inner wall of the accommodating trough 300 of the hinge 30 form an interference fit. When the main body 32 rotates relative to the removable box 2 to fix to the magnetic attraction member 34, the protrusion 320a of the main body 32 is engaged with the first recess 302a. Therefore, the first recess 302a of the hinge 30 located within the accommodating trough 300 can achieve the function of retaining the protrusion 320a of the main body 32 and prevent the main body 32 from easily rotating relative to the removable box 2 and thus separating from the magnetic attraction member 34. When the main body 32 rotates relative to the removable box 2 to be perpendicular to the surface of the removable box 2, the protrusion 320a of the main body 32 is engaged with the second recess 302b. Therefore, the second recess 302b of the hinge 30 located within the accommodating trough 300 can achieve the function of retaining the protrusion 320a of the main body 32 and prevent the main body 32 from easily rotating relative to the removable box 2 and thus not being perpendicular to the surface of the removable box 2.

In other words, when the main body 32 of the fixed handle assembly 3 rotates relative to the removable box 2 to fix to the magnetic attraction member 34, not only does the magnetic attraction member 34 of the fixed handle assembly 3 continuously apply the fixing force to the main body 32, but also the protrusion 320a of the main body 32 is retained by the first recess 302a of the hinge 30 so as to enhance the function of fixing the main body 32. Furthermore, during transportation of the removable box 2 when the main body 32 of the fixed handle assembly 3 is held by a user, the protrusion 320a of the main body 32 is retained by the second recess 302b of the hinge 30 so as to prevent the main body 32 from easily rotating and shaking. Hence, the possibility of damage to internal components packaged in the removable box 2 (e.g., a portable HDD) due to shaking can be reduced.

In the embodiment of the disclosure, the protrusion 320a of the main body 32 is located at a first operation surface 320b of the end 320, and the first operation surface 320b is perpendicular to the pivot 36.

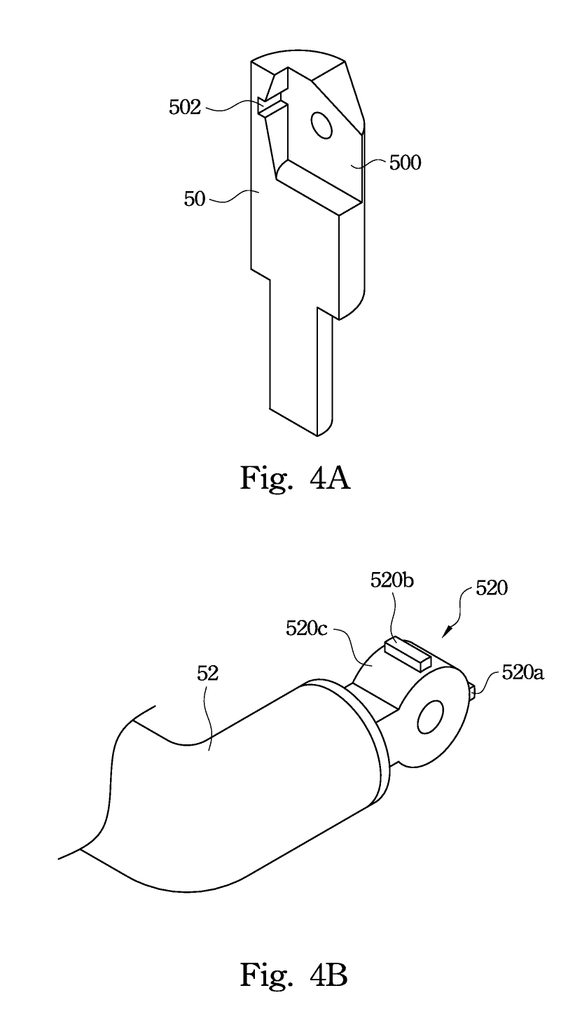

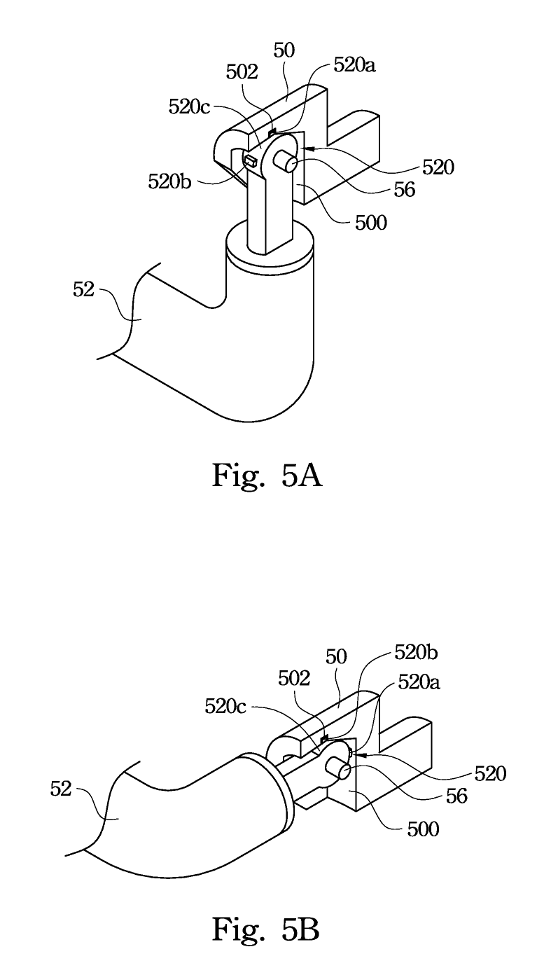

FIG. 4A is a perspective view of another embodiment of the hinge 50 in FIG. 1A. FIG. 4B is a partial perspective view of another embodiment of the main body 52 in FIG. 1A. FIG. 5A is a partial sectional view showing the main body 52 in FIG. 4B assembled to the hinge 50 in FIG. 4A, in which the main body 52 rotates relative to the removable box 2 to approach the surface of the removable box 2. FIG. 5B is another partial sectional view showing the main body 52 in FIG. 4B assembled to the hinge 50 in FIG. 4A, in which the main body 52 rotates relative to the removable box 2 to be perpendicular to the surface of the removable box 2.

As shown in FIG. 4A to FIG. 5B, the hinge 50 includes an accommodating trough 500. A pivot 56 is pivotally connected to the hinge 50 and passes through the accommodating trough 500. An end 520 of the main body 52 is pivotally connected to the hinge 50 by the pivot 56 and is located at least partially in the accommodating trough 500 so as to rotate within the accommodating trough 500 and make the main body 52 rotate relative to the removable box 2 to approach the surface of the removable box 2 (as FIG. 5A shows) or be perpendicular to the surface of the removable box 2 (as FIG. 5B shows). When the main body 52 rotates relative to the removable box 2 to approach the removable box 2, the main body 52 is parallel to the surface of the removable box 2.

As shown in FIG. 4A to FIG. 5B, the hinge 50 includes a recess 502 within the accommodating trough 500, and the end 520 of the main body 52 includes a first protrusion 520a and a second protrusion 520b. During the rotation of the main body 52 relative to the removable box 2, each of the first protrusion 520a and the second protrusion 520b of the main body 52 and the inner wall of the accommodating trough 500 of the hinge 50 form an interference fit. When the main body 52 rotates relative to the removable box 2 to be parallel to the surface of the removable box 2, the first protrusion 520a of the main body 52 is engaged with the recess 502. Therefore, the recess 502 of the hinge 50 located within the accommodating trough 500 can achieve the function of retaining the first protrusion 520a of the main body 52 and preventing the main body 52 from easily rotating relative to the removable box 2 and thus separating from the surface of the removable box 2. When the main body 52 rotates relative to the removable box 2 to be perpendicular to the surface of the removable box 2, the second protrusion 520b of the main body 52 is engaged with the recess 502. Therefore, the recess 502 of the hinge 50 located within the accommodating trough 500 can achieve the function of retaining the second protrusion 520b of the main body 52 and preventing the main body 52 from easily rotating relative to the removable box 2 and thus not being perpendicular to the surface of the removable box 2.

In other words, when the main body 52 rotates relative to the removable box 2 to approach the surface of the removable box 2, not only does the magnetic attraction member 34 of the fixed handle assembly 3 continuously apply the fixing force to the main body 52, but also the first protrusion 520a of the main body 52 is retained by the recess 502 of the hinge 50 so as to enhance the function of fixing the main body 52. Furthermore, during transportation of the removable box 2 when the main body 52 is held by a user, the second protrusion 520b of the main body 52 is retained by the recess 502 of the hinge 50 so as to prevent the main body 52 from rotating and shaking. Hence, the possibility of damage to internal components packaged in the removable box 2 due to shaking can be reduced.

In the embodiment of the disclosure, the first protrusion 520a and the second protrusion 520b of the main body 52 are located at a second operation surface 520c of the end 520, and the second operation surface 520c is parallel to the pivot 56.

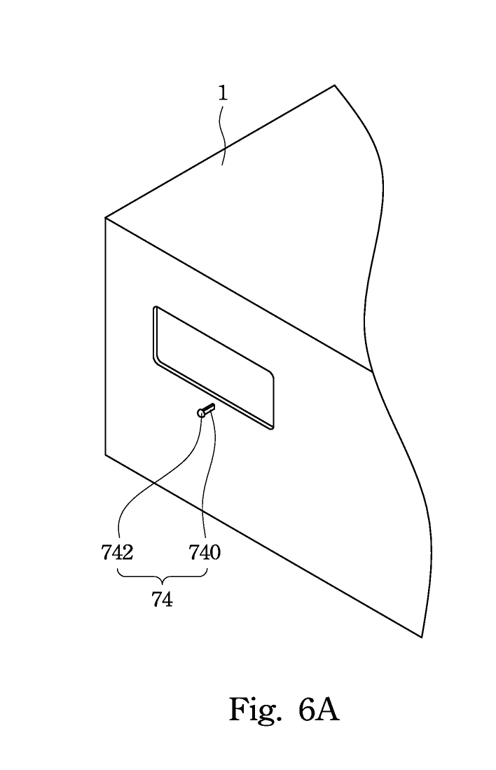

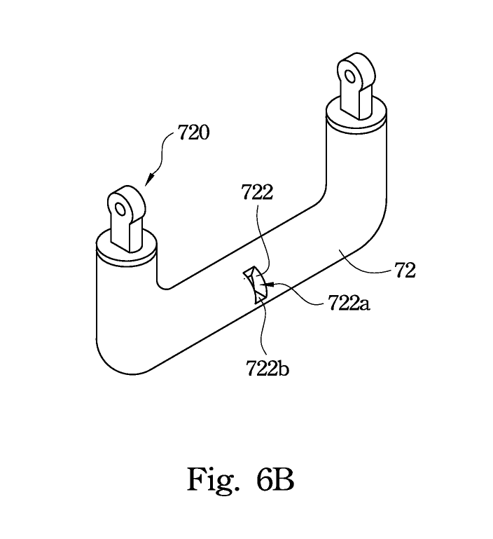

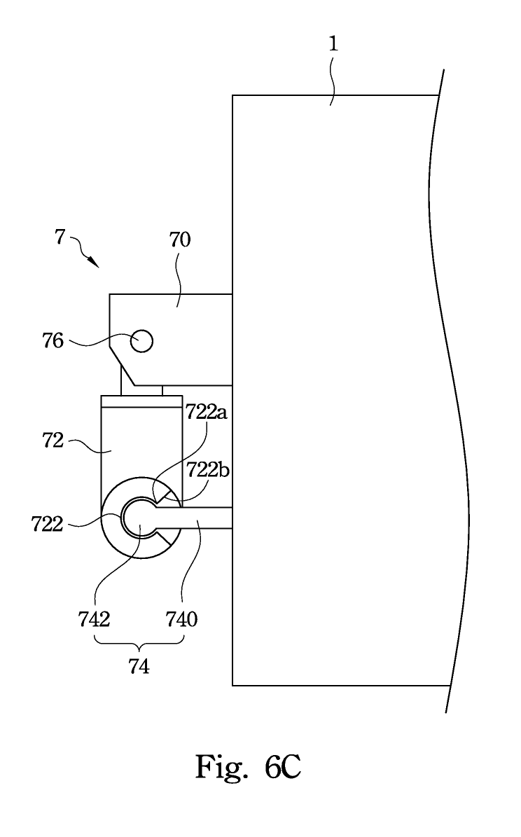

FIG. 6A is a perspective view showing a hook 74 of a fixed handle assembly 74 that is disposed on the host housing 1 according to another embodiment of the disclosure. FIG. 6B is a perspective view of a main body 72 of the fixed handle assembly 7 according to another embodiment of the disclosure. FIG. 6C is another side view of FIG. 1B that adopts the fixed handle assembly 7 in FIG. 6B according to another embodiment of the disclosure, in which the main body 72 rotates relative to the removable box 2 to fix to the hook 74, and an engaging trough 722 of the main body 72 is shown in cross section.

As shown in FIG. 6A to FIG. 6C, the fixed handle assembly 7 includes a hinge 70, the main body 72, a pivot 76, and the hook 74. The hinge 70 of the fixed handle assembly 7 is disposed on the removable box 2. The main body 72 of the fixed handle assembly 7 includes an end 720, and the end 720 of the main body 72 is pivotally connected to the hinge 70 by using the pivot 76. The hook 74 of the fixed handle assembly 7 is disposed on the host housing 1. In the embodiment of the disclosure, the hook 74 of the fixed handle assembly 7 includes a neck portion 740 and a head portion 742, and the size of the head portion 742 is larger than the size of the neck portion 740. The main body 72 of the fixed handle assembly 7 includes the engaging trough 722 having an opening 722a, and the size of the opening 722a is smaller than the size of the head portion 742 of the hook 74. When the main body 72 is pressed toward the hook 74, the opening 722a of the engaging trough 722 is compressed by the head portion 742 of the hook 74 to expand. After the head portion 742 of the hook 74 passes through the opening 722a of the engaging trough 722 and then is engaged with the engaging trough 722, the opening 722a of the engaging trough 722 elastically recovers to limit movement of the head portion 742 and prevent the head portion 742 from separating from the engaging trough 722. In this state, the main body 72 is close to the surface of the removable box 2 (as shown in FIG. 6C). Therefore, the main body 72 must receive a separating force that is larger than a fixing force that the hook 74 applies to the main body 72 so that the head portion 742 of the hook 74 can compress the opening 722a of the engaging trough 722 to expand and separate from the engaging trough 722, thereby allowing the main body 72 to rotate relative to the removable box 2 and separate from the hook 74. That is, when the removable box 2 is assembled to the host housing 1 and in use, the retaining function of the hook 74 of the fixed handle assembly 7 with respect to the main body 72 can ensure that the main body 72 does not shake and collide with the removable box 2.

In an embodiment of the disclosure, in order to allow the head portion 742 of the hook 74 to pass through the opening 722a of the engaging trough 722, the material of the main body 72 can include an elastic material such as rubber, but the disclosure is not limited in this regard.

As shown in FIG. 6B and FIG. 6C, the main body 72 can further include a guiding surface 722b located at the inner wall of the opening 722a so that the size of the opening 722a gradually expands from the engaging trough 722. Therefore, when the main body 72 is pressed toward the hook 74, the head portion 742 of the hook 74 can easily enter the engaging trough 722 through the opening 722a as a result of being guided by the guiding surface 722b.

In the embodiment of the disclosure, the hinge 70 and the end 720 of the main body 72 can also make use of the embodiment shown in FIG. 2A and FIG. 2B (i.e., the retaining combinations of each of the first recess 302a and the second recess 302b and the protrusion 320a) or the embodiment shown in FIG. 4A and FIG. 4B (i.e., the retaining combinations of the recess 502 and each of the first protrusion 520a and the second protrusion 520b) so as to achieve the function of preventing the main body 72 from shaking during transportation or operation of the removable box 2.

According to the foregoing recitations of the embodiments of the disclosure, it can be seen that the fixed handle assembly can be applied to a removable box and can prevent a main body of the fixed handle assembly from shaking to thereby make noise or collide with the removable box, and can also prevent damage to the removable box that may be caused by vibration during transportation or operation of the removable box. During transportation of the removable box, the main body can be fixed to stand erect relative to a surface of the removable box by an engaging structure of the fixed handle assembly that is disposed between a hinge of the fixed handle assembly and the main body. During operation of the removable box after the removable box is assembled to a host housing, the main body can be fixed to abut against the surface of the removable box by a fixing member of the removable box that is disposed on the host housing. Furthermore, the fixed handle assembly of the disclosure does not include components that undergo fatigue failure, so the useful lives of the components included in the fixed handle assembly are increased. Moreover, the components of the fixed handle assembly are simple and small in number, so the fixed handle assembly can be easily assembled without having to use specially designed assembly tools to thereby reduce overall costs.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A fixed handle assembly used to a removable box that is removably assembled to a host housing, the fixed handle assembly comprising:
a hinge disposed on the removable box;
a main body pivotally connected to the hinge; and
a fixing member disposed on the host housing, wherein the main body is rotatable relative to the removable box to approach the fixing member so as to be fixed by the fixing member detachably;
wherein when a separating force received by the main body is larger than a fixing force that the fixing member applies to the main body, the main body is capable of rotating relative to the removable box and separating from the fixing member.

2. The fixed handle assembly of claim 1, wherein the fixing member is a magnetic attraction member, a material of the main body comprises metal, and when the main body rotates relative to the removable box to approach the magnetic attraction member, the magnetic attraction member attracts and fixes the main body.

3. The fixed handle assembly of claim 2, wherein the main body comprises an end and a pivot, the hinge comprises an accommodating trough, the end is pivotally connected to the hinge by the pivot and is located at least partially in the accommodating trough so as to rotate within the accommodating trough, and the main body is capable of rotating relative to the removable box to approach or separate from the fixing member.

4. The fixed handle assembly of claim 3, wherein the hinge comprises a first recess and a second recess within the accommodating trough, the end comprises a protrusion engageable with the first recess or the second recess, when the main body rotates relative to the removable box to fix to the fixing member, the protrusion is engaged with the first recess, and when the main body rotates relative to the removable box to be perpendicular to a surface of the removable box, the protrusion is engaged with the second recess.

5. The fixed handle assembly of claim 4, wherein the protrusion is located at a first operation surface of the end, and the first operation surface is perpendicular to the pivot.

6. The fixed handle assembly of claim 3, wherein the hinge comprises a recess within the accommodating trough, the end comprises a first protrusion and a second protrusion engageable with the recess, when the main body rotates relative to the removable box to fix to the fixing member, the first protrusion is engaged with the recess, and when the main body rotates relative to the removable box to be perpendicular to a surface of the removable box, the second protrusion is engaged with the recess.

7. The fixed handle assembly of claim 6, wherein the first protrusion and the second protrusion are located at a second operation surface of the end, and the second operation surface is parallel to the pivot.

8. The fixed handle assembly of claim 3, wherein when the main body rotates relative to the removable box to fix to the fixing member, the main body is parallel to a surface of the removable box.

9. The fixed handle assembly of claim 1, wherein the fixing member is a hook, the main body comprises an engaging trough, and when the main body rotates relative to the removable box to approach the hook, the hook is engaged in the engaging trough to fix the main body.

10. The fixed handle assembly of claim 9, wherein the hook comprises a neck portion and a head portion, the engaging trough has an opening, the opening is compressible by the head portion to expand, and the opening elastically recovers to limit the movement of the head portion after the head portion passes through the opening and then is engaged with the engaging trough.

11. The fixed handle assembly of claim 9, wherein the main body comprises an end and a pivot, the hinge comprises an accommodating trough, the end is pivotally connected to the hinge by the pivot and is located at the accommodating trough so as to rotate within the accommodating trough, and the main body is capable of rotating relative to the removable box to approach or separate from the fixing member.

12. The fixed handle assembly of claim 11, wherein the hinge comprises a first recess and a second recess within the accommodating trough, the end comprises a protrusion engageable with the first recess or the second recess, when the main body rotates relative to the removable box to fix to the fixing member, the protrusion is engaged with the first recess, and when the main body rotates relative to the removable box to be perpendicular to a surface of the removable box, the protrusion is engaged with the second recess.

13. The fixed handle assembly of claim 12, wherein the protrusion is located at a first operation surface of the end, and the first operation surface is perpendicular to the pivot.

14. The fixed handle assembly of claim 11, wherein the hinge comprises a recess within the accommodating trough, the end comprises a first protrusion and a second protrusion engageable with the recess, when the main body rotates relative to the removable box to fix to the fixing member, the first protrusion is engaged with the recess, and when the main body rotates relative to the removable box to be perpendicular to a surface of the removable box, the second protrusion is engaged with the recess.

15. The fixed handle assembly of claim 14, wherein the first protrusion and the second protrusion are located at a second operation surface of the end, and the second operation surface is parallel to the surface of the pivot.

16. The fixed handle assembly of claim 11, wherein when the main body rotates relative to the removable box to fix to the fixing member, the main body is parallel to a surface of the removable box.
